(19) United States
(12) Patent Application Publication
(10) Pub. No.: US 2006/0092978 A1
(43) Pub. Date: May 4, 2006

(54) Method and apparatus for developing a virtual assistant for a communication

(76) Inventors: Ajita John, Holmdel, NJ (US); Reinhard P. Klemm, Basking Ridge, NJ (US); Doree D. Seligmann, New York, NY (US)

Correspondence Address: Ryan, Mason & Lewis, LLP, Suite 205, 1300 Post Road, Fairfield, CT, 06824, US

(21) Appl. No.: 10/989,104

(22) Filed: Nov. 15, 2004

Related U.S. Application Data
(63) Continuation-in-part of application No. 10/955,918, filed on Sep. 30, 2004.

(51) Int. Cl. H04J 3/24

(52) U.S. Cl. 370/473

(57) ABSTRACT

Methods and apparatus are provide for developing a virtual assistant for at least one party of a communication. A developer provides one or more virtual assistant software modules that control an execution of the virtual assistant; and also provides a set of proxy methods that are called by the virtual assistant software modules to provide one or more desired functions. The developer may optionally be presented with a library containing one or more virtual assistant software modules or proxy methods. The developer can optionally revise the one or more virtual assistant software modules or proxy methods selected from the library, for example, based on a selection of one or more supported external applications.

### CROSS-REFERENCE TO RELATED APPLICATIONS

The present application is a continuation-in-part of U.S. patent application Ser. No. 10/955,918, entitled “Method and Apparatus for Providing Communication Tasks in a Workflow,” (Attorney Docket No. 504056-A-01 (John)), filed Sep. 30, 2004 and incorporated by reference herein.

### FIELD OF THE INVENTION

The present invention relates generally to methods and apparatus for communicating with one or more users, and more particularly, to techniques for providing a virtual assistant to one or more participants of a communication.

### BACKGROUND OF THE INVENTION

In today's communication environment, communication devices must support a number of functions in order to implement various desired applications and to satisfy the ever-increasing expectations of users. For example, one or more external applications may need to monitor or control events on a device, monitor the device status, control the device and its current capabilities, or render their user interfaces on the device. In addition, users often wish to multi-task while participating in a communication, such as a conference call, and perform one or more additional tasks on the same or a different device than supports the primary communication. Such tasks may or may not be related to the communication. Examples of the tasks that are related to the communication include changing one or more call settings, obtaining information about the other participants involved in the communication, sending or receiving messages or being notified of events, such as messages that are received during the communication, all without interrupting the primary communication. Examples of tasks that are not related to the communication include the invocation of external applications from the device and interaction with these applications through the device. Thus, to support multi-tasking, even further functionality may be required and the desired functionality may be spread among a number of devices. Supporting such functionality on communication devices, especially traditional and unmodified communication devices, as well as spreading the functionality among a number of devices proves to be a formidable challenge.

A number of techniques have been proposed or suggested to assist a user during a communication. For example, Avaya Inc. has proposed a WiVa interface that provides a telephone interface into a specific application called POCCS that includes the WiVa interface. The WiVa interface follows a user request/response model where the user speaks a predefined command that initiates a desired action by the WiVa interface. For example, the WiVa interface allows a user to initiate a call or to obtain information regarding, for example, the availability or location of another person. In addition, VCON Corp. has proposed a system, referred to as VCON Interactive Group Communication System 2000 (ICG 2000), that allows text messages sent between users to be rendered as a voice “whisper” if the target user is on a call. While such techniques have extended the functionality that is available to users, and have increased user efficiency, they suffer from a number of limitations, which, if overcome, could further extend the utility of communication devices. A need therefore exists for improved methods and apparatus for providing virtual assistants or agents to one or more participants in a communication.

### SUMMARY OF THE INVENTION

Generally, methods and apparatus are provide for developing a virtual assistant for at least one party of a communication. A developer provides one or more virtual assistant software modules that control an execution of the virtual assistant; and also provides a set of proxy methods that are called by the virtual assistant software modules to provide one or more desired functions. The developer may optionally be presented with a library containing one or more virtual assistant software modules or proxy methods. The developer can optionally revise the one or more virtual assistant software modules or proxy methods selected from the library, for example, based on a selection of one or more supported external applications.

The virtual assistant software modules allow signals from the virtual assistant to be interpreted. The proxy methods convert signals between the virtual assistant software modules and one or more external applications.

A more complete understanding of the present invention, as well as further features and advantages of the present invention, will be obtained by reference to the following detailed description and drawings.

### BRIEF DESCRIPTION OF THE DRAWINGS

FIG. 1 illustrates a network environment in which the present invention can operate;

FIG. 2 illustrates aspects of the network environment of FIG. 1 in further detail;

FIG. 3 is a schematic block diagram of an exemplary proxy of FIG. 1 or 2;

FIGS. 4A and 4B, collectively, provide exemplary pseudo-VXML code for the master script of FIG. 2;

FIGS. 5A through 5D, collectively, illustrate exemplary pseudo code for a set of abstract methods that are implemented by a derived (customized) EJB;

FIG. 6 is a flow chart describing an exemplary implementation of the assistant servlet of FIG. 2; and

FIG. 7 is a schematic block diagram of an exemplary personal voice assistant development platform.

### DETAILED DESCRIPTION

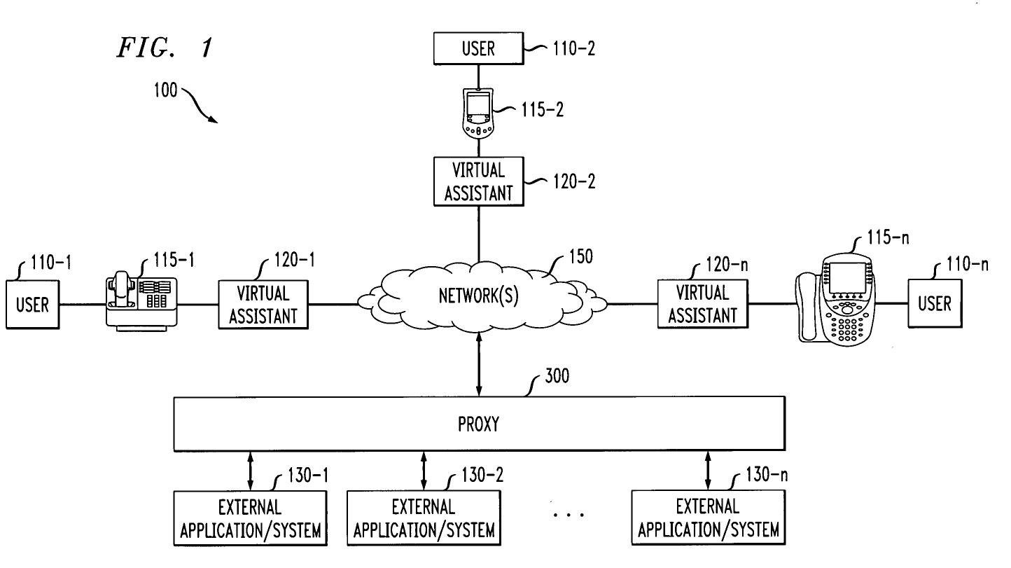

FIG. 1 illustrates a network environment 100 in which the present invention can operate. As shown in FIG. 1, one or more users 110-1 through 110-n (hereinafter, collectively referred to as users 110) communicate with one another or with one or more external applications or systems 130-1 through 130-n (hereinafter, collectively referred to as external applications 130) over one or more networks 150. As shown in FIG. 1, each user 110 has one or more associated devices 115-1 through 115-n (hereinafter, collectively referred to as devices 115). It is noted that the one or more networks 150 may include any combination of wired or wireless data or voice public and private networks.

According to one aspect of the present invention, each user 10 has an associated virtual assistant 120-1 through 120-n. In the exemplary embodiment discussed herein, the virtual assistants are deployed in the context of voice communications. Thus, the virtual assistants 120-1 through 120-n are collectively referred to as personal voice assistants 120. It is noted that although the present invention is illustrated in the context of personal voice assistants for voice communications, the invention can also be applied to many other communication media, such as instant messaging.

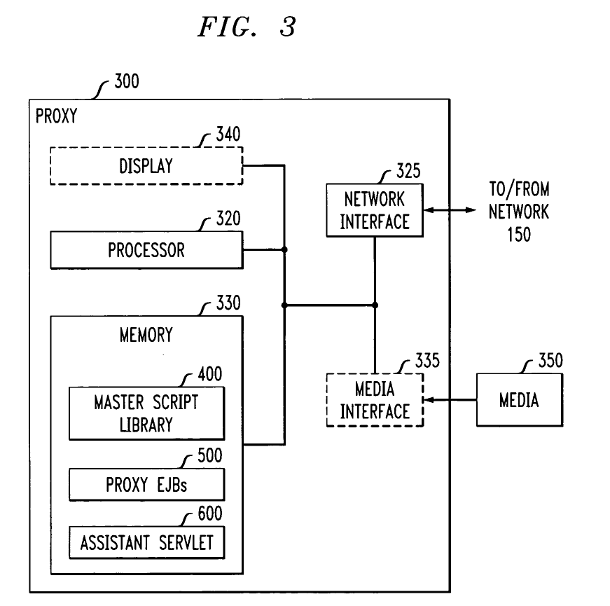

According to another aspect of the invention, functionality of the personal voice assistants is allocated between the personal voice assistants 120 and a coupled software system, referred to as a proxy 300, discussed below in conjunction with FIG. 3. Generally, the proxy 300 allows a developer to selectively include functionality in the personal voice assistant 120 of a given user or set of users.

As used herein, a personal voice assistant 120 is a software conduit that connects a user device 115, such as a telephone, to the proxy 300. The personal voice assistant 120 allows two-way in-band signaling between the user of the user device 115 and the proxy 300. The proxy 300 mediates between the personal voice assistant 120 and external applications 130 that the personal voice assistant 120 (or the user 110) wishes to interact with. The proxy 300 interprets signals from the personal voice assistant 120 and converts them into commands for the external applications 130, and the proxy 300 converts commands, messages and data, from the external applications 130 into signals understood by the personal voice assistant 120.

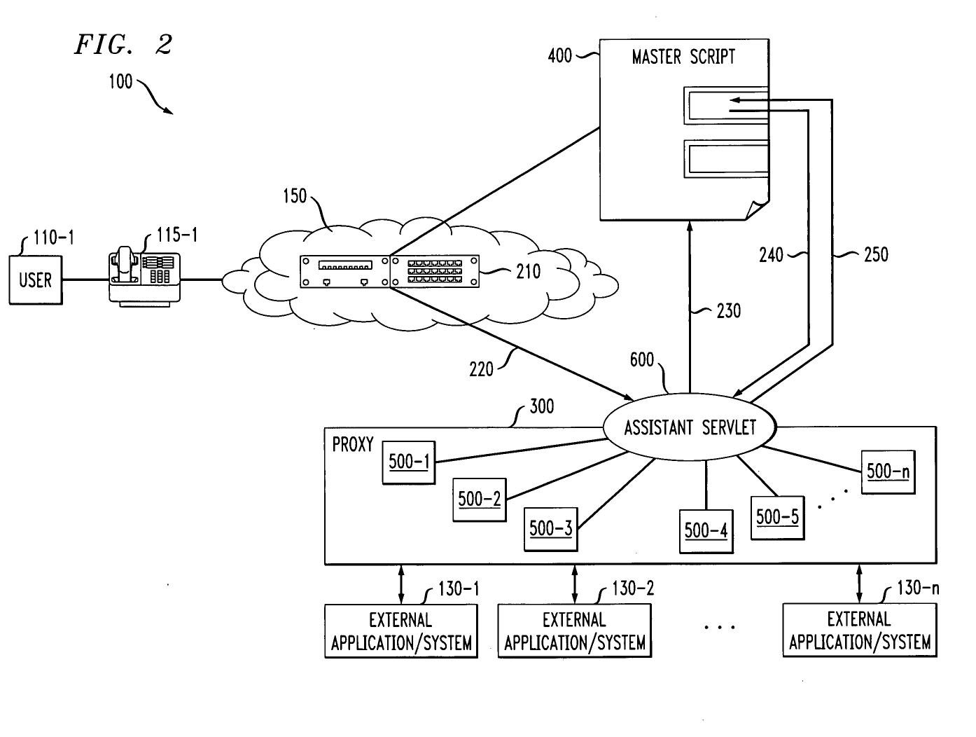

It is noted that the proxy 300 communicates with each personal voice assistant by means of a data connection through the network(s) 150. It is further noted that the personal voice assistant 120 may be injected into a communication by the device 115 of a user or by a node in the network 150 that is connected to the device 115, as discussed below in conjunction with FIG. 2. In the former case, the device 115 must support the execution of the personal voice assistant 120 (e.g., parsing VXML in the exemplary embodiment, as discussed below). In the latter case, however, a network node needs to support the execution of the personal voice assistant 120 but no modifications are necessary to the device 115.

To the user 110, the personal voice assistant 120 is a voice or phone keypad-operated user interface into the external applications and systems 130 and allows the user to trigger arbitrary functionality, such as computations and data or message retrieval in the external applications and systems 130. Moreover, the personal voice assistant 120 allows the user 110 to send text and audio messages to other users 110 having personal voice assistants 120 and to receive such messages from other users 110 (or to have an interactive communication) by way of the proxy 300 without the intervention of external applications and systems 130. The feedback from the proxy 300 to the user 110 consists of voice or audio output that is audible only to this user, for example, by means of a telephone headset associated with the device 115. There is generally a one-to-one relationship between personal voice assistants 120 and devices 115. Thus, the proxy 300 can clearly identify the device 115 and its associated user or users 110 that requests functionality from the proxy 300 or from external applications and systems 130. For the sake of this discussion, it is assumed that there is a one-to-one relationship between users 110 and devices 115.

To the proxy 300, the personal voice assistant 120 appears as a voice and audio output and dialog device, tied to a specific user 110. The personal voice assistant 120 allows the proxy 300 to relay, for example, computational results, messages, audio files and dialogs to the user 110 and notify the user 110 of events. The objects sent to the user 110 originate at the external applications and systems 130, other users 110, or the proxy 300 itself.

### Selective Functionality of Personal Voice Assistant

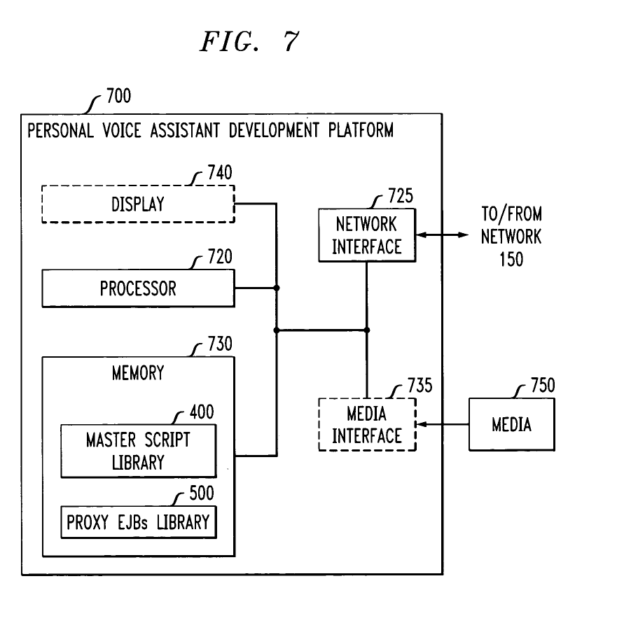

As discussed further below, the functionality of the proxy 300 and the spectrum of commands available to the user 110 of the personal voice assistant 120 must be aligned with the external applications and systems 130 through customization. In other words, the personal voice assistant 120 and proxy 300 must be tailored to the functionality or subset of functionality supported by the external applications and systems 130. The personal voice assistant 120 and proxy 300 therefore constitute a programming framework that allows the customization of commands of the personal voice assistant 120 based on the selection of supported external applications or systems 130. An exemplary personal voice assistant development platform 700 is discussed below in conjunction with FIG. 7. Generally, the framework provides a generic personal voice assistant 120 and proxy 300 that can optionally be extended by programmers to match the desired functionality in the external applications and systems.

Exemplary Personal Voice Assistant Functionality

For example, the personal voice assistant programming framework described herein may allow a developer to selectively include the following functions in a personal voice assistant for a given user or set of users:

i. retrieval of the names and locations of conference call participants;

ii. obtaining a weather forecast or stock quotes;

iii. sending a text or audio message to another user;

iv. doing a database search;

v. sending a dialog to another user (such as “can you meet me at 2 PM today? Press 1 for yes and 2 for no”);

vi. computing the current value of a stock portfolio;

vii. restarting a crashed software application (it is assumed that the proxy 300 has relayed a notification to the user 110 of the crash of an application that an external system 130 monitors; the personal voice assistant 120 might give the user 110 choices of how to respond to the crash, including an application restart option, by means of a dialog; this is particularly useful in situations where a firewall prevents the user 110 from directly accessing the computing environment that hosts the crashed application); and

viii. turning on or off message forwarding from voice mail systems to the personal voice assistant 120.

In addition, each personal voice assistant 120 generally supports a number of default functions. It is noted that the personal voice assistant is generally silent and operates in the background unless activated by the user 110 or the proxy 300. For example, the personal voice assistant 120 is generally active during call establishment and at times when the user 110 or the proxy 300 invokes the personal voice assistant 120.

A personal voice assistant 120 can also optionally send user and device status reports to the proxy 300, which stores the status reports and can make them available to other users 110 and external applications and systems 130 (subject to any appropriate access rights). Specifically, the personal voice assistant 120 can report whether the user 120 is on a phone call and if so, identify the phone call. In this manner, the personal voice assistant 120 allows user phone and call presence. This also allows the personal voice assistant 120 to target specific phone calls over which to render voice and audio received from the proxy 300.

The ability of the personal voice assistant 120 to report the status of user device 15 allows device crashes and device connectivity issues to be monitored by the proxy 300 and relayed to external applications and systems 130 that need to monitor the status of user devices 115.

Exemplary Information Relayed to User by Proxy

Thus, to support one or more of the above functions, the proxy 300 may have to relay one or more of the following exemplary outputs from external applications and systems 130 to the user 10:

i. forwarding a voice mail message left for the user 110 on a voice mail system;

ii. sending a text message (rendered as voice) from another user 110-n to this user 110;

iii. sending an alert (rendered as voice) from a workflow system to this user 110;

iv. playing a signal tone that alerts the user 110 to an upcoming appointment on his or her calendar;

v. force call termination;

vi. bridging in another call party 110-n;

vii. alerting the user 110 to a subscribed event; and

viii. notifying the user 110 of another user 110-n becoming present on her phone device 115.

Exemplary Dialog Between User and Proxy

The personal voice assistant framework of the present invention also supports dialogs between the user 110 and the proxy 300 through the personal voice assistant. For example, input from the user 10 to the personal voice assistant 120 and output from the proxy 300 to the user 110 can be interleaved. Such dialogs can either be invoked by the user 110 or by the proxy 300. For example, the personal voice assistant programming framework described herein may allow a developer to selectively include functions in a personal voice assistant to support one or more of the following interactive exchanges:

i. the proxy 300 sends a signal tone to the user 110 indicating the arrival of a new message; when the user 110 gets a chance, the user 110 retrieves the message by pressing a button on the device 115, to which the proxy 300 responds with the text of the message, and the personal voice assistant 120 renders the text (or an audio version thereof);

ii. the user 110 wants to retrieve a stock quote; the user 110 presses a button on the phone 115 and the proxy 300 requests a (spoken) input of the stock symbol; the proxy 300 retrieves the requested stock quote through an external application 130 and returns the stock quote to the personal voice assistant 120, which renders the quote to the user 110; and

iii. another user 110-n sends a complete dialog that asks the recipient user 110 to first agree to meet the originating user 110-n at a specified time, then asks the recipient 110 to pick one of two time alternatives, then one of two venue alternatives.

FIG. 2 illustrates aspects of the network environment 100 of FIG. 1 in further detail. As previously indicated, the personal voice assistant 120 may be injected into a communication by the device 115 of a user 110 or by a node in the network 150. In the exemplary implementation shown in FIG. 2, the personal voice assistant 120 of a user 110 is injected into a communication by a node 210 in the network 150. For example, for a voice communication, the personal voice assistant 120 is injected as audio information by a node 210 in the telephone subsystem, such as a switch 210 connected to the user device 115.

In one preferred implementation, the personal voice assistants 120 are always on. In other words, a user's phone 115 is permanently connected to the personal voice assistant 120. If the underlying phone subsystem does not support the “always on” feature, i.e., the personal voice assistant 120 does not execute in the phone device 115 or permanently on a phone switch 210, either the proxy 300 or the phone subsystem injects the personal voice assistant 120 into each party of every phone call. In one exemplary implementation, this is achieved by having the phone switch 210 invoke and execute the personal voice assistant 120 when the user 110 makes or receives a call on the device 115. In another variation, if the user 110 has an intelligent phone 115 (such as a softphone or a sophisticated hard phone with the ability to execute arbitrary programs), the phone device 115 itself can invoke and execute the personal voice assistant 120 when the user 110 makes or receives a call.

The “always on” feature of the personal voice assistant 120 allows the personal voice assistant 120 to serve as a universal voice user interface without having to use a keyboard or a computer. This is of particular value in environments where users 110 cannot operate a keyboard with their hands or where there is no data connection between the user 110 and the external applications and systems 130 (due, for example, to connectivity issues or firewalls).

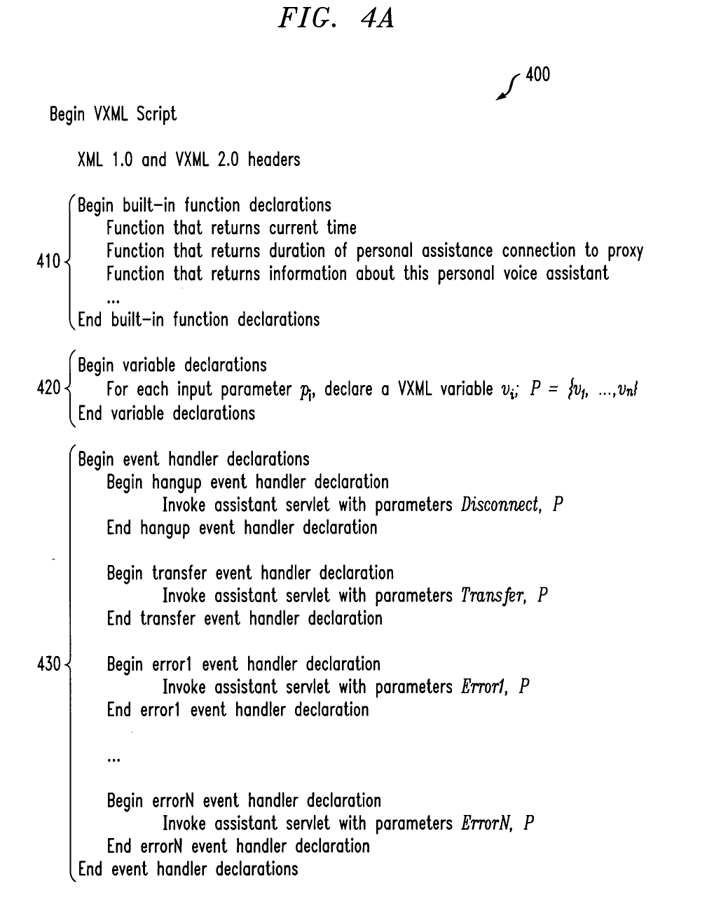

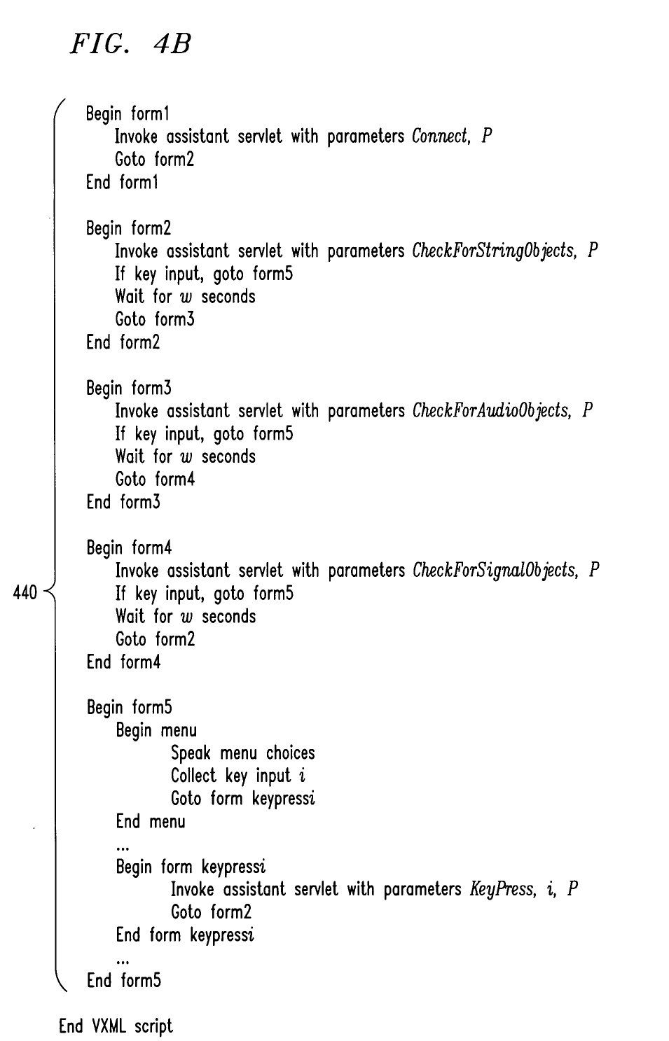

Generally, the personal voice assistants 120 should not depend on the underlying phone subsystem, such as Plain Old Telephone Systems (POTS) or Voice Over IP (VoIP) systems. VXML is a standard that is independent of the underlying phone subsystem. In one exemplary implementation described herein, the personal voice assistant 120 is embodied using a VXML script 400, discussed below in conjunction with FIG. 4. Thus, the exemplary VXML personal voice assistants 120 can run in any type of phone subsystem that supports the VXML standard.

The VXML script 400 silently runs in the background of each phone call. The VXML script 400 gets invoked by the switch 210 before (“always on”) or when a call is placed by or to the user 110 and executed on a VXML engine that is coupled with the switch 210. The VXML engine 210 retrieves the VXML script 400 from the proxy 300 before the call is established, as shown by request 220. The request 220 may include configurable parameters passed by the VXML engine 210 to the proxy 300 to identify the appropriate personal voice assistant VXML script for this call (or the VXML script may be dynamically generated based on the parameters). Thus, the proxy 300 may optionally return a personal voice assistant 120 that is customized based on parameters that the VXML engine 210 forwards to the proxy 300, such as the caller's or callee's phone number and/or based on parameters that the proxy 300 has knowledge of (such as time of the day or the external applications and systems 130).

The disclosed VXML script 400 is generic in the sense that the developer of a personal voice assistant 120 extends the VXML script 400 with customized subdialogs. As discussed further below in conjunction with FIG. 4, in the exemplary embodiment, the subdialogs are not part of the VXML script 400, but rather are referenced in the VXML script 400, and get requested by the VXML script 400 from the proxy 300. Subdialogs are requested by the VXML script 400 when a VXML event occurs. For example, a VXML event may include a button press, a spoken command, a call establishment event or a hangup event. As discussed further below, the personal voice assistants 120 are customized by programming the proxy 300 to return a customized VXML subdialog.

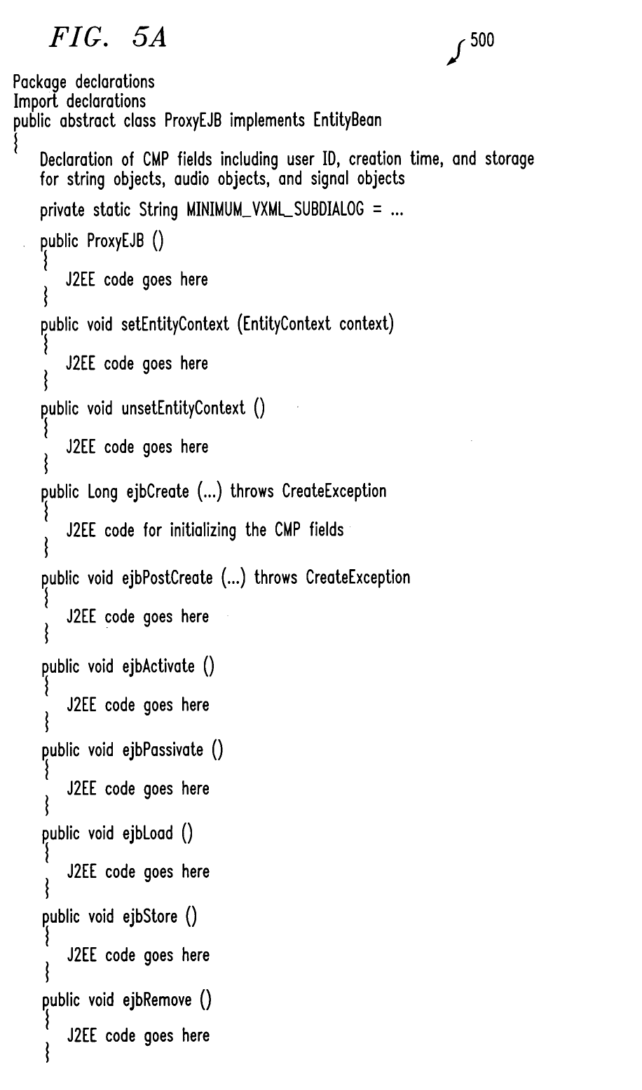

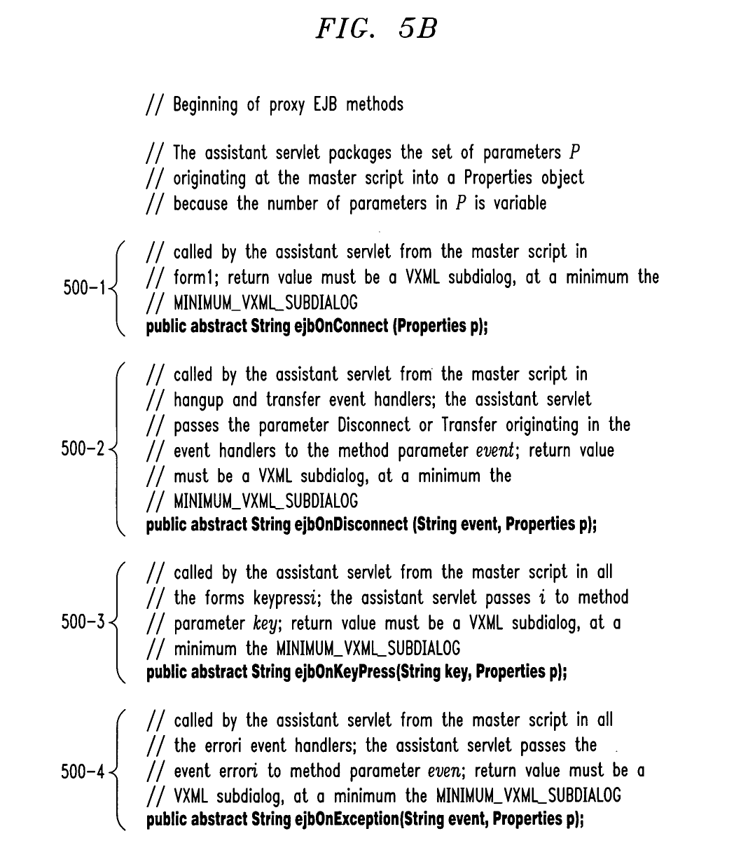

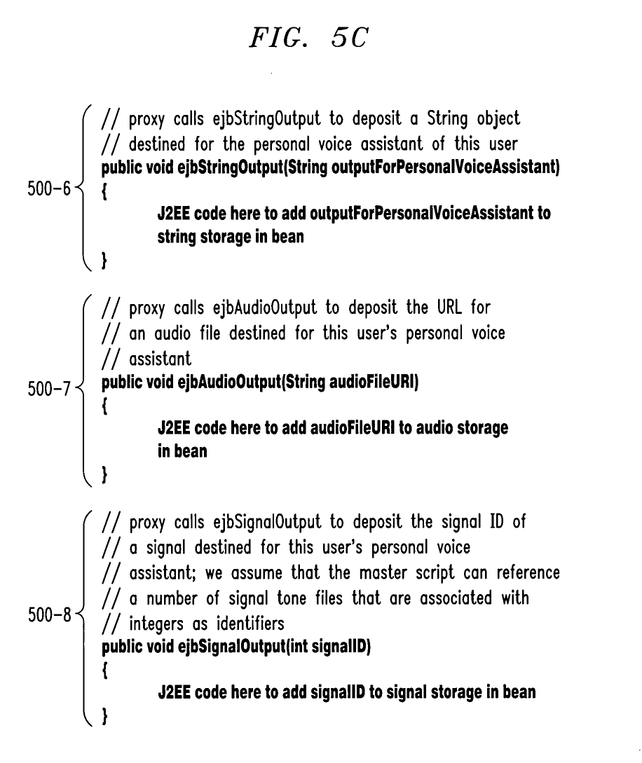

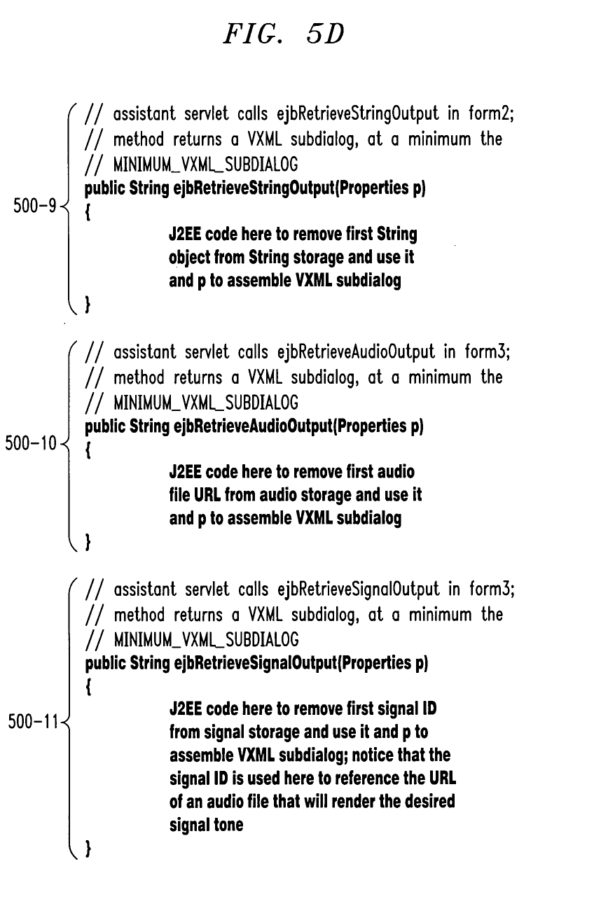

The proxy 300 is implemented, for example, using Java 2 Enterprise Edition (J2EE) from Sun. The proxy 300 is customized to support the functionality of external applications and systems 130 by extending dedicated Enterprise Java Bean(s) (EJBs) 500, discussed below in conjunction with FIG. 5, in the proxy 300, referred to herein as proxy EJBs 500. Generally, a proxy EJB 500 contains a set of exemplary abstract methods 500-1 through 500-n that a derived (customized) EJB has to implement. The derived EJB 500 customizes the proxy 300 for the desired one or more external applications and systems 130.

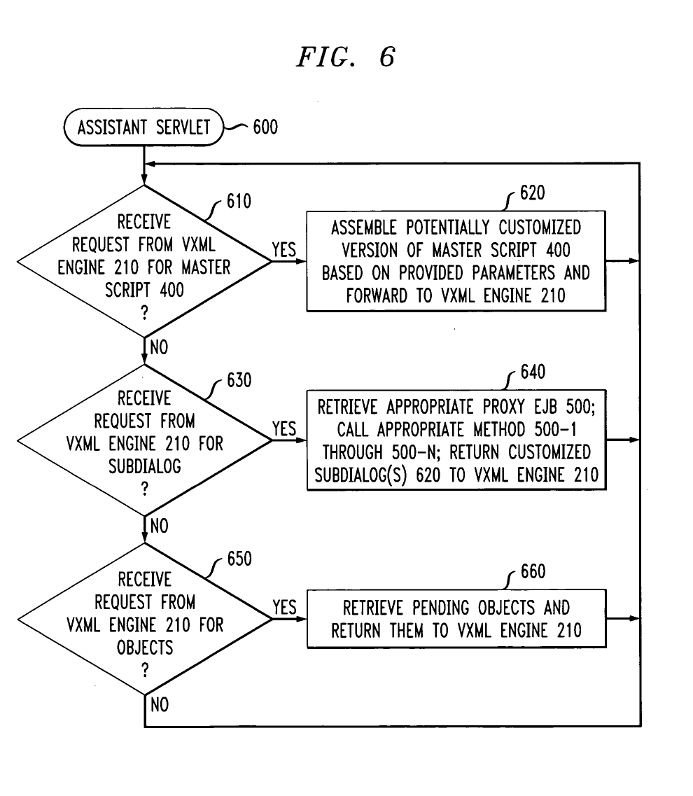

The VXML subdialogs that the developer customizes are assembled in the bodies of the exemplary proxy EJB methods 500-1 through 500-n. Alternatively, the bodies of the exemplary proxy EJB methods 500-1 through 500-n may return a string, such as text, or URL of an audio file that the assistant servlet 600 (discussed below) can incorporate into a VXML subdialog. This further reduces the effort required for customizing a personal voice assistant but has the disadvantage of also limiting the flexibility of the VXML subdialogs. The VXML script, also referred to as a master script 400, that incorporates references to these subdialogs are part of the disclosed programming framework and is generally not visible to the developer. Following the request 220, the master script 400 gets returned in a response 230 to the VXML engine 210 by a dedicated assistant servlet 600, discussed below in conjunction with FIG. 6, that is part of the proxy 300. The assistant servlet 600 is also the servlet that gets invoked by the VXML engine 210 when the engine 210 requests subdialogs specified in the master script 400. In the case of subdialog invocation, the assistant servlet 600 retrieves the appropriate (derived) proxy EJB 500 and calls one of the methods above 500-1 through 500-n and returns customized subdialogs in a response 250.

FIG. 3 is a schematic block diagram of an exemplary proxy 300. The proxy 300 comprises a computer system that optionally interacts with media 350. The proxy 300 comprises a processor 320, a network interface 325, a memory 330, a media interface 335 and an optional display 340. Network interface 325 allows the proxy 300 to connect to a network 150, while media interface 335 allows the proxy 300 to interact with media 350, such as a Digital Versatile Disk (DVD) or a hard drive. Optional video display 340 is any type of video display suitable for interacting with a human user of the proxy 300. Generally, video display 340 is a computer monitor or other similar video display.

As shown in FIG. 3 and discussed further below in conjunction with FIGS. 4 through 5, respectively, the exemplary memory 330 stores the master script library 400, a set of proxy EJBs 500 and the assistant servlet 600.

FIGS. 4A and 4B, collectively, provide exemplary pseudo-VXML code for the master script 400. It is noted that the master script 400 may actually be one in a library of completed master scripts or may be derived from one of potentially several master script templates in a library of master scripts templates. A master script template is a VXML master script with placeholders that the assistant servlet 600 replaces at run-time with actual values to yield a concrete master script 400. The assistant servlet 600 receives input parameters in the request 220 from the VXML engine 210 that requests the master script 400. The assistant servlet 600 uses these parameters to pick a master script 400 or to pick a master script template and to parameterize it to generate the master script 400. Examples of input parameters include a user identifier, user phone number, VXML engine type and identifier and a session identifier generated by the proxy 300.

As shown in FIG. 4A, the exemplary pseudo-VXML code 400 includes sections 410, 420 for declaring built-in functions and variables, respectively. In addition, the events error1, . . . , errorN referenced in section 430 of the pseudo-VXML code 400 are exceptions and errors that the VXML engine 210 can detect (for example, error.semantic). As shown in FIG. 4A, each event invokes the assistant servlet 600, which may be done through a VXML subdialog element. Thus, whatever the assistant servlet 600 returns is expected to be a VXML subdialog that the master script 400 will render. Speech input is not shown in the pseudocode 400 but would be handled in a similar manner, as would be apparent to a person of ordinary skill in the art.

As shown in FIG. 4B, the exemplary pseudo-VXML code 400 includes a section 440 for defining forms that are executed sequentially, in a known manner. Each form in section 440 invokes the assistant servlet 600 with an indication of the event and parameters. The assistant servlet 600 returns a VXML subdialog that is rendered by the master script 400. Generally, form1 corresponds to the initial greeting or other information presented to the user upon connection to the personal voice assistant 120. In addition, forms 2 through 4 correspond to monitoring for the deposit of string, audio and signal objects, respectively, in the proxy EJB 500 that is associated with this personal voice assistant 120.

Each form invokes the assistant servlet 600. Upon returning from the assistant servlet 600 and rendering the subdialog returned by the assistant servlet 600, each form generally monitors for key input (or spoken commands), and if detected, processes the input according to the menu definitions in form5. Forms form2 through form4 execute continuously to monitor for the deposit of string, audio and signal objects, respectively, in the proxy EJB 500 that is associated with this personal voice assistant 120, until a user input is detected, which causes a branch to form5 to process the user input, before returning to form2. The parameter w is a configurable wait time (e.g., 30 seconds).

FIGS. 5A through 5D, collectively, illustrate exemplary pseudo code for a set 500 of abstract methods 500-1 through 500-n that are implemented by a derived (customized) EJB. The derived EJB 500 customizes the proxy 300 for the desired one or more external applications and systems 130. It is noted that the proxy EJB methods 500, as well as the CMP field accessor methods, have to be propagated to the bean's remote and local interfaces. The portion of the proxy EJB methods 500 shown in FIG. 5A is mandated by the J2EE platform, as understood by those of ordinary skill in the art.

As previously indicated, the developer of a personal voice assistant 120 needs to extend the class ProxyEJB by implementing exemplary proxy EJB methods 500-1 through 500n. As shown in FIG. 5B, the following methods are implemented in the exemplary embodiment:

i. ejbOnConnect 500-1 (called once call is established);

ii. ejbOnDisconnect 500-2 (called right before call is dropped);

iii. ejbOnKeyPress 500-3 (called upon button press event);

iv. ejbOnSpeechInput 500-4 (called upon spoken event, but not shown in FIG. 5B for ease of illustration due to similarity with ejbOnKeyPress 500-3); and

v. ejbOnException 500-5 (called if exception is detected by VXML engine).

In addition, as shown in FIG. 5C, the following methods deposit objects of various types for pick-up by the personal voice assistant 120 (for each output type in the exemplary embodiment):

i. ejbStringOuput 500-6;

ii. ejbAudioOutput 500-7; and

iii. ejbSignalOutput 500-8 (where signals are brief signal tones, such as a beep with a specified frequency).

In addition, as shown in FIG. 5D, the following corresponding retrieval methods retrieve objects of various types from the personal voice assistant 120 (for each output type in the exemplary embodiment):

i. ejbRetrieveStringOutput 500-9;

ii. ejbRetrieveAudioOutput 500-10; and

iii. ejbRetrieveSignalOutput 500-11.

In the exemplary implementation, these methods are implemented by the proxy 300 and do not need to be provided by the developer.

FIG. 6 is a flow chart describing an exemplary implementation of the assistant servlet 600. As shown in FIG. 6, the exemplary assistant servlet 600 performs a number of tests to monitor for various requests from the VXML engine 210. If a request is detected during step 610 for the master script 400, the assistant servlet 600 returns the master script 400 to the VXML engine 210 during step 620.

If a request is detected during step 630 for a subdialog, the assistant servlet 600 retrieves the appropriate (derived) proxy EJB 500 and calls one of the methods above 500-1 through 500-n and returns the customized subdialogs during step 640.

If a request is detected during step 650 for pending objects, the assistant servlet 600 retrieves the pending objects and returns them to the VXML engine 210 during step 660. Program control then returns to step 610 and continues in the manner described above. It is noted that such requests for pending objects can be considered a special case of the request for subdialogs processed during steps 630 and 640, because pending objects can be packaged and returned through subdialogs.

The proxy EJBs 500 can optionally be configured with J2EE transaction settings “Required” and UserTransactions in the assistant servlet as well as the external applications and systems can be started before accessing any of the ejbRetrieveXXXOutput and ejbXXXOutput methods, respectively. External applications and systems 130 that are not built on J2EE can be connected to the proxy via transacted J2EE 1.4 connectors. After having accessed any of these methods 500, the assistant servlet 600 or external application or system 130 commits the UserTransactions. If such a UserTransaction fails (rolls back) for any reason (such as an exception encountered or a failure to commit), the assistant servlet 600 or the external application or system 130 can periodically keep trying to re-run the transaction until it either succeeds or a configurable maximum number of retries has been reached. If the network connection between the VXML engine 210 and the assistant servlet 600 breaks or times out during an invocation of the assistant servlet 600 by the master script 400, however, the assistant servlet 600 will not try to re-run the latest transaction but rather wait for the master script 400 to re-request the invocation. Unless the proxy 300 becomes non-functional during the course of its operation due to a proxy software crash or a crash of the operating system/hardware of the machine(s) that the proxy 300 executes on or due to some other reason, this mechanism guarantees a once-and-only-once semantics for the deposit into and retrieval of objects from the proxy. In other words, when an external application or system 130 deposits an object into the proxy 300, even intermittent failures of the proxy 300, of the network(s) 150 connecting the two, of the operating system or hardware that the proxy executes on, or similar, will not lead to a loss or duplication of the object in the proxy 300. Likewise, if the master script 400 wants to retrieve an object from the proxy 300 and encounters some failure during the retrieval (whether it is in the VXML engine 210, the network 150, the proxy 300 itself or elsewhere along the way), the object will neither get lost nor rendered twice to the user of the personal voice assistant 120.

By using proxy EJBs rather than plain Java objects, the proxy 300 also reaps other benefits of the J2EE platform, most notably scalability, realibility, availability, and security. Moreover, a functional benefit of using EJBs is the ability of a reporting engine or other application to run SQL or EJB-QL queries against the set of proxy EJBs 500. For example, an application might be interested in retrieving the names of all users and devices that are currently connected to their personal voice assistant and could do so very easily by using an SQL or EJB-QL query.

### EXAMPLES

For example, to render an initial greeting upon call establishment, the master script 400 connects to the assistant servlet 600. The assistant servlet 600 uses the identity of the user 110 of the personal voice assistant 120, conveyed to the servlet 600 through VXML subdialog parameters, retrieves the derived proxy EJB 500 for this user 110, and calls the ebjOnConnect method 500-1 on this EJB. The ejbOnConnect method 500-1 has been customized by the developer to return a potentially empty VXML subdialog. The assistant servlet 600 subsequently renders the subdialog as voice or as an audio file. The subdialog can be compiled, for example, from parameterizable templates stored in a database or in the code of the proxy 300 or retrieved from the external applications and systems 130.

After the initial greeting, the master script 400 waits for button presses (or voice commands) from the user 110. Thus, on high performance VXML engines, the master script 400 could also perform continuous voice recognition and wait for the user to speak one of a set of possible keywords. When the user 110 presses a button on the phone 115, the master script 400 forwards the button press event to the proxy 300 via the assistant servlet 600. The assistant servlet 600 then retrieves the derived proxy EJB 500 for this user 110 and calls the ejbOnKeyPress method 500-3, which creates a VXML subdialog depending on which button was pressed and returns the subdialog to the master script 400 through the assistant servlet 600. As in the case of the initial greeting, the subdialog can be compiled from a variety of sources, in most cases by executing code in the external applications and systems 130, and render output either as voice or as an audio file. Other events similarly lead to calls to derived proxy EJB methods 500 and rendering of subdialogs.

When an external application or system 130 or the proxy 300 wants to send an object, such as the result of a computation, a message, notification, alert, event or audio file, to the user 110, the external application or system 130 or the proxy 300 hands over the object to the proxy 300, which deposits the object in a proxy EJB that is assigned exclusively to the designated user 110. Specifically, the proxy 300 calls the appropriate ejbOutput method 500-6, 500-7 or 500-8 (depending on the output type) on the proxy EJB. The master script 400 periodically invokes the assistant servlet 600 in a polling loop and uses a flag to convey to the assistant servlet 600 that the assistant servlet 600 should look for the presence of new objects in the proxy EJB by calling the appropriate ejbRetrieveOutput method 500-9, 500-10 or 500-11. Retrieved objects will be used to compile a VXML subdialog within the master script 400 and deleted from the proxy EJB or marked as old.

Once the subdialog has been rendered, the master script 400 returns to the beginning of the polling loop where it waits for user button presses for a specified time (for example, 30 seconds) before repeating the polling process, as discussed above in conjunction with the forms in the master script 400 of FIG. 4.

Thus, the personal voice assistant 120 is an example of media enhancements. The exemplary personal voice assistant 120 is a master program 400 that can optionally be injected into every call and voice conference. This master program 400 can be configurable to incorporate application-specific and user-selected functionality, as discussed herein. Generally, the personal voice assistant 120 speaks a configurable greeting to a conferee upon joining a conference. It stays silent on a call until one of two events occurs:

1. The user 110 invokes the personal voice assistant 120 through pressing a key on a phone (or a spoken command).

2. A message has been sent to the user 110 as part of the execution of a flow, for example, by a communication application development and execution platform (See, U.S. patent application Ser. No. 10/955,918, entitled “Method and Apparatus for Providing Communication Tasks in a Workflow,” (Attorney Docket No. 504056-A-01 (John)), filed Sep. 30, 2004 and incorporated by reference above).

In the first case, the 110 user is presented with a voice menu, only audible to this user 110, that gives access to the entity relationship model, in particular, to user data and allows retrieval of information about the other conferees or parties of a call such as the current number of conferees or parties, their identities, and their locations. Moreover, the personal voice assistant 120 allows the user 110 to change settings that are in effect only for the duration of the call and that have relevance to the call. An example is the rerouting of text messages destined for the user to this call. The second case above refers to the ability of the communication application development and execution platform to send an alert to a user on a call initiated by the communication application development and execution platform. The alert translates either into a signal tone that the user 110 will hear or the voice rendition of the text of the alert, depending on the preferences of the sending flow and the recipient. In the former case, the recipient has the option of invoking the personal voice assistant at any time and retrieving the alert text then.

In addition, a user 110 can obtain information about a conference call through the shared voice channel, such as the number of participants, their names and locations, and the total elapsed time during the conference. Users can access other information in a similar fashion. The personal voice assistant 120 enables the dissemination of information on a call, the handling of alerts and whispers, as well as subscribing and unsubscribing to events, such as incoming email and instant messages. The personal voice assistant 120 works closely with the shared voice channel. The agent 120 is a largely silent companion on each call and can be activated either by the user or by events destined for a user, as previously indicated. Users can conduct private conversations with other conferees through their respective personal voice assistants 120. The personal voice assistant 120 complements a Web-based user portal that allows users to respond to requests initiated by flows and to monitor collected information as well as the display of events relevant to a user.

### Personal Voice Assistant Development Platform

FIG. 7 is a schematic block diagram of an exemplary personal voice assistant development platform 700. The personal voice assistant development platform 700 provides a programming framework to generate personal voice assistants, as described herein. The personal voice assistant development platform 700 comprises a computer system that optionally interacts with media 750. The personal voice assistant development platform 700 comprises a processor 720, a network interface 725, a memory 730, a media interface 735 and an optional display 740. Network interface 725 allows the personal voice assistant development platform 700 to connect to a network 150, while media interface 735 allows the personal voice assistant development platform 700 to interact with media 750, such as a Digital Versatile Disk (DVD) or a hard drive. Optional video display 740 is any type of video display suitable for interacting with a human user of the personal voice assistant development platform 700. Generally, video display 740 is a computer monitor or other similar video display.

As shown in FIG. 7, the exemplary memory 730 stores one or more scripts in the master script template library 400 and one or more proxy EJBs in a method 500. In this manner, the personal voice assistant development platform 700 allows a developer to optionally leverage the templates in the master script template library 400 and proxy EJBs 500. For example, the proxy EJBs 500 facilitate the development process by merely requiring the developer to fill in user-specific or application-specific functionality. In addition, the developer can fully create a master script template 400, pick an existing master script template, or leverage some or all of the master script 400 from a library of available options. In addition, a proxy EJB method library can contain predefined proxy EJB methods that the developer can pick, and it can contain proxy EJB method templates that the developer can use to derive proxy EJB methods from. The developer also has the option of adding new proxy EJB methods and proxy EJB method templates to this library. For example, the library 500 may contain a fully specified ejbOnConnect method 500-1 that simply greets the associated user by username, or a template ejbOnConnect method 500-1 that greets the user with an announcement of the name of the personal voice assistant 120 and the current time and date.

The personal voice assistant development platform 700 thus generates master scripts 400 and proxy EJBs 500 that adhere to the division of labor architecture between the personal voice assistants 120 and the proxy 300.

System and Article of Manufacture Details

As is known in the art, the methods and apparatus discussed herein may be distributed as an article of manufacture that itself comprises a computer readable medium having computer readable code means embodied thereon. The computer readable program code means is operable, in conjunction with a computer system, to carry out all or some of the steps to perform the methods or create the apparatuses discussed herein. The computer readable medium may be a recordable medium (e.g., floppy disks, hard drives, compact disks, or memory cards) or may be a transmission medium (e.g., a network comprising fiber-optics, the world-wide web, cables, or a wireless channel using time-division multiple access, code-division multiple access, or other radio-frequency channel). Any medium known or developed that can store information suitable for use with a computer system may be used. The computer-readable code means is any mechanism for allowing a computer to read instructions and data, such as magnetic variations on a magnetic media or height variations on the surface of a compact disk.

The computer systems and servers described herein each contain a memory that will configure associated processors to implement the methods, steps, and functions disclosed herein. The memories could be distributed or local and the processors could be distributed or singular. The memories could be implemented as an electrical, magnetic or optical memory, or any combination of these or other types of storage devices. Moreover, the term “memory” should be construed broadly enough to encompass any information able to be read from or written to an address in the addressable space accessed by an associated processor. With this definition, information on a network is still within a memory because the associated processor can retrieve the information from the network.

It is to be understood that the embodiments and variations shown and described herein are merely illustrative of the principles of this invention and that various modifications may be implemented by those skilled in the art without departing from the scope and spirit of the invention.

We claim:

1. A method for developing a virtual assistant for at least one party of a communication, comprising:
providing one or more virtual assistant software modules that control an execution of said virtual assistant; and
providing a set of proxy methods that are called by said one or more virtual assistant software modules to provide one or more desired functions.

2. The method of claim 1, wherein said one or more virtual assistant software modules are selected from a library.

3. The method of claim 2, further comprising the step of revising said one or more virtual assistant software modules selected from said library.

4. The method of claim 1, wherein one or more of said proxy methods are selected from a library.

5. The method of claim 4, further comprising the step of revising said one or more of said proxy methods selected from said library.

6. The method of claim 1, wherein said one or more virtual assistant software modules allow signals from said virtual assistant to be interpreted.

7. The method of claim 1, wherein one or more of said set of proxy methods convert signals from said virtual assistant into commands for one or more external applications.

8. The method of claim 1, wherein one or more of said set of proxy methods convert signals from one or more external applications to signals for said virtual assistant.

9. The method of claim 1, wherein one or more of said set of proxy methods is a derived proxy Enterprise Java Bean method.

10. The method of claim 1, further comprising the step of customizing said virtual assistant based on a selection of one or more supported external applications.

11. The method of claim 1, further comprising the step of allowing one or more functions to be selectively included in said virtual assistant of a given user or set of users.

12. A method for developing a virtual assistant for at least one party of a communication, comprising:
selecting one or more virtual assistant software modules from a library, said one or more virtual assistant software modules controlling an execution of said virtual assistant; and
selecting one or more proxy methods from a library, said one or more proxy methods being called by said one or more virtual assistant software modules to provide one or more desired functions.

13. The method of claim 12, further comprising the step of revising said one or more virtual assistant software modules selected from said library.

14. The method of claim 12, further comprising the step of revising said one or more of said proxy methods selected from said library.

15. The method of claim 12, wherein one or more of said proxy methods is a derived proxy Enterprise Java Bean method.

16. The method of claim 12, further comprising the step of customizing said one or more virtual assistant software modules and said one or more proxy methods based on a selection of one or more supported external applications.

17. A system for developing a virtual assistant for at least one party of a communication, comprising:
a memory; and
at least one processor, coupled to the memory, operative to:
provide one or more virtual assistant software modules that controls an execution of said virtual assistant; and
provide a set of proxy methods that are called by said one or more virtual assistant software modules to provide one or more desired functions.

18. The system of claim 17, wherein said processor is further configured to present a library containing one or more of virtual assistant software modules and proxy methods.

19. The system of claim 18, wherein said processor is further configured to receive a developer selection of one or more of said virtual assistant software modules and proxy methods in said library.

20. The system of claim 19, wherein said processor is further configured to process modifications from a developer of said selected one or more of virtual assistant software modules and proxy methods.

21. A system for use by a developer in developing a virtual assistant for at least one party of a communication, comprising:
a memory; and
at least one processor, coupled to the memory, operative to:
provide a library of one or more virtual assistant software modules for controlling an execution of said virtual assistant;
provide a library of proxy methods that are called by said one or more virtual assistant software modules to provide one or more desired functions; and
receive a selection from said developer of one or more of said virtual assistant software modules and said proxy methods.

22. The system of claim 21, wherein said processor is further configured to process modifications from a developer of said selected one or more of virtual assistant software modules and proxy methods.

23. An article of manufacture for use by a developer in developing a virtual assistant for at least one party of a communication, comprising a machine readable medium containing one or more programs which when executed implement the step of:
providing a library of one or more virtual assistant software modules for controlling an execution of said virtual assistant;
providing a library of proxy methods that are called by said one or more virtual assistant software modules to provide one or more desired functions; and
receiving a selection from said developer of one or more of said virtual assistant software modules and said proxy methods.
